(19) United States
(12) Patent Application Publication
(10) Pub. No.: US 2026/0129416 A1
(43) Pub. Date: May 7, 2026

(54) SERVICE EXECUTION METHODS, DEVICES, AND STORAGE MEDIA

(71) Applicant: Alipay (Hangzhou) Digital Service Technology Co., Ltd., Hangzhou (CN)

(72) Inventor: Long MEI, Hangzhou (CN)

(21) Appl. No.: 19/381,441

(22) Filed: Nov. 6, 2025

(30) Foreign Application Priority Data
Nov. 7, 2024 (CN) 202411587184.6

(51) Int. Cl. H04W 4/50; H04W 4/80; H04W 12/08; H04W 12/69

(52) U.S. Cl. CPC H04W 4/50; H04W 4/80; H04W 12/08; H04W 12/69

(57) ABSTRACT

A service execution method is applied to a terminal, and includes: establishing a short-range connection with a short-range communication device in response to a short-range connection operation of a user; sending a read request to the short-range communication device based on the short-range connection with the short-range communication device, to cause the short-range communication device to return verification information based on the short-range connection; receiving the verification information returned by the short-range communication device; sending an access request comprising the verification information to a service platform, to cause the service platform to return a service interface based on the verification information; and receiving and displaying the service interface returned by the service platform, for the user to execute a service based on the displayed service interface.

### CROSS-REFERENCE TO RELATED APPLICATIONS

This application claims priority to Chinese Patent Application No. 202411587184.6, filed on Nov. 7, 2024, the entire content of which is incorporated herein by reference.

### TECHNICAL FIELD

This specification relates to the computer field, and in particular, to service execution methods, devices, and storage media.

### BACKGROUND

With the development of Internet technologies, users can execute various services by scanning a QR code, for example, scan a QR code of a lottery to participate in the lottery. For offline services, users usually need to execute the services in particular locations. For example, a province holds a shopping fund subsidy campaign, and users need to receive and use subsidy funds at a specified location in the province. If users can obtain subsidy funds only by scanning a QR code of the campaign, users that are not in the province can obtain subsidy funds via the QR code of the campaign sent by other persons, which harms the interests of the users in the province. This is because the QR code is easy to copy and spread through screenshots. Other persons can send the QR code of the campaign to users who do not satisfy the regional need. Therefore, for a service executed via a QR code, it may be difficult to guarantee that users executing the service satisfy the regional need.

### SUMMARY

According to a first aspect of this specification, a service execution method is applied to a terminal and includes: establishing a short-range connection with a short-range communication device in response to a short-range connection operation of a user; sending a read request to the short-range communication device based on the short-range connection with the short-range communication device, to cause the short-range communication device to return verification information based on the short-range connection; receiving the verification information returned by the short-range communication device; sending an access request including the verification information to a service platform, to cause the service platform to return a service interface based on the verification information; and receiving and displaying the service interface returned by the service platform, for the user to execute a service based on the displayed service interface.

According to a second aspect of this specification, a service execution method is applied to a service platform and includes: receiving an access request that is sent by a terminal and includes verification information, where the verification information is obtained by the terminal based on a short-range connection established with a short-range communication device; performing qualification verification on a user based on the verification information; obtaining a service interface when the verification succeeds; and returning the service interface to the terminal, for the user to execute a service based on the service interface displayed by the terminal.

According to a third aspect of this specification, a service execution method is applied to a short-range communication device and includes: establishing a short-range connection with a terminal of a user in response to a short-range connection operation of the user; receiving a read request sent by the terminal based on the short-range connection; determining verification information based on the read request; and returning the verification information to the terminal based on the short-range connection, to cause the terminal to send the verification information to a service platform, and to obtain and display a service interface returned by the service platform, for the user to execute a service displayed in the service interface.

According to a fourth aspect of this specification, a service execution device includes: a processor; and a memory storing instructions executable by the processor, wherein the processor is configured to perform the service execution method in the first, second, or third aspect.

According to a fifth aspect of this specification, a non-transitory computer-readable storage medium has stored therein instructions that, when executed by a processor of a device, cause the device to perform the service execution method in the first, second, or third aspect.

### BRIEF DESCRIPTION OF DRAWINGS

The accompanying drawings described here are used to provide a further understanding of this specification and constitute a part of this specification. The example embodiments of this specification and descriptions thereof are used to explain this specification, and do not constitute an improper limitation on this specification. In the accompanying drawings:

FIG. 1 is a flowchart illustrating a service execution method according to an example embodiment.

FIG. 2 is a schematic diagram illustrating the service execution method according to an example embodiment.

FIG. 3 is a schematic diagram illustrating a short-range connection according to an example embodiment.

FIG. 4 is a flowchart illustrating determining to-be-decoded service information according to an example embodiment.

FIG. 5 is a flowchart illustrating qualification verification according to an example embodiment.

FIG. 6 is a schematic diagram illustrating a service execution apparatus according to an example embodiment.

FIG. 7 is a schematic diagram illustrating an electronic device according to an example embodiment.

### DETAILED DESCRIPTION OF EMBODIMENTS

Example embodiments are described in detail herein and shown in the accompanying drawings. When the following description relates to the accompanying drawings, unless specified otherwise, the same numbers in different accompanying drawings represent the same or similar elements. Implementations described in the following example embodiments do not represent all implementations consistent with this specification. On the contrary, the implementations are merely examples consistent with some aspects of one or more embodiments of this specification.

The emergence of QR codes and intelligent terminals provides many conveniences for people's lives. People can use intelligent terminals and QR codes to execute services such as payment, participating in a lottery, retail promotion, brand activities, member point exchange, and ticket verification. However, for offline services, there are still some disadvantages in using QR codes to execute the services. For example, when a service is an offline lottery, a campaign organizer asks users to participate on site, and the users can use intelligent terminals to scan a QR code posted by the campaign organizer at a specified offline location to participate in the lottery. However, another person may photograph the QR code and send the QR code to another user who is not on site, so that the user who is not on site participates in the lottery. Actually, the user who is not on site participating in the lottery does not satisfy the regional need of the campaign organizer for the users participating in the lottery. It can also be understood that the QR code is easy to copy and spread. Therefore, if a service is executed via a QR code, it may be difficult to guarantee that users executing the service satisfy the regional need. The service execution method provided in this specification can make users executing a service satisfy a regional need.

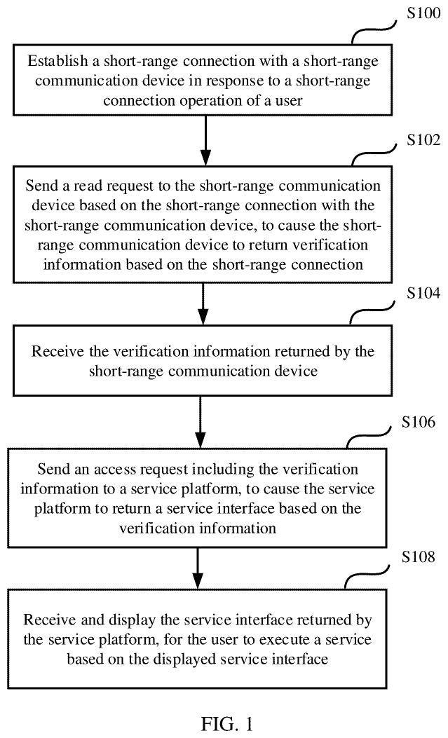

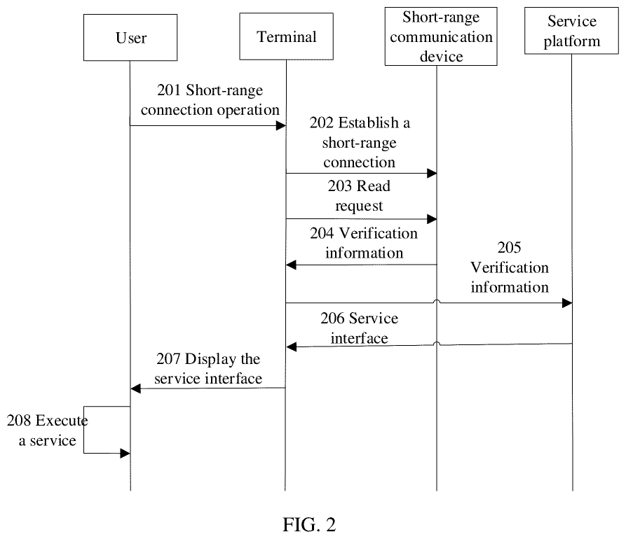

FIG. 1 is a flowchart illustrating a service execution method according to an example embodiment. FIG. 2 is a schematic diagram illustrating the service execution method according to an example embodiment.

The service execution method may be performed by one or more devices of a terminal used by a user, a service platform, or a short-range communication device. The devices can communicate directly or indirectly to obtain and exchange data, so that the user executes a service. This specification does not limit a type of the service executed by the user.

The user can first obtain a service interface before executing the service. When the service interface is obtained, to satisfy a regional need for the service, the user can establish a short-range connection with the short-range communication device by using the terminal. The short-range communication device can be placed at a location that satisfies the regional need for the service.

Referring to FIGS. 1 and 2, the service execution method may include the following steps.

Step S100: Establish a short-range connection with a short-range communication device in response to a short-range connection operation of a user.

For example, the short-range communication device includes at least one of a near field communication (NFC) chip, a radio frequency identification (RFID) chip, and a Bluetooth device. The NFC chip and the RFID chip can exist in the form of a card, etc., or can be placed inside an electronic device. This is not limited in this specification. When the short-range communication device is an NFC chip or an RFID chip, the user can make the terminal approach the short-range communication device, so that a distance between the terminal and the short-range communication device is less than a predetermined distance, and the terminal establishes a short-range connection with the short-range communication device (202) in response to a short-range connection operation of the user (201). When the short-range communication device is a Bluetooth device, the user can enable a Bluetooth connection function of the terminal, and search for and connect to the Bluetooth device, so that the terminal establishes a short-range connection with the Bluetooth device, to obtain a service interface subsequently.

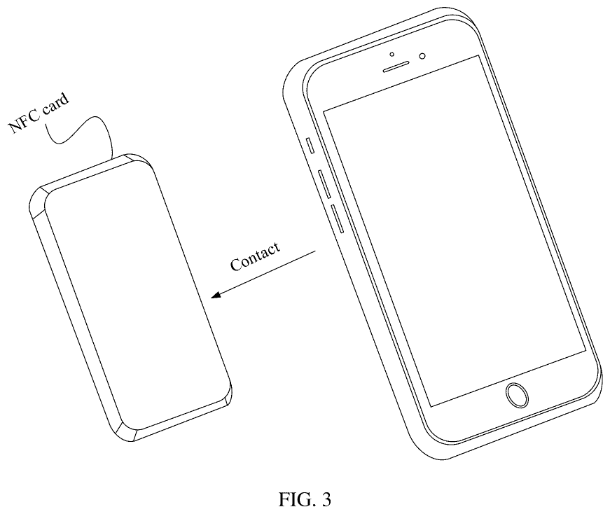

FIG. 3 is a schematic diagram illustrating a short-range connection according to an example embodiment.

As shown in FIG. 3, in this example embodiment, the short-range communication device is an NFC card, and the terminal is a smartphone. The user makes the smartphone be in contact with the NFC card, so that the smartphone establishes a short-range connection with the NFC card, and short-range communication can be performed.

The user who executes the service needs to establish the short-range connection between the terminal and the short-range communication device to obtain the service interface, and the short-range connection can be established only when the distance between the terminal and the short-range communication device is relatively short. Therefore, the user needs to make the distance between the terminal and the short-range communication device satisfy the predetermined distance for establishing a short-range connection, so that the distance between the user and the short-range communication device is limited. In this case, a service initiator needs only to place the short-range device at a location of an offline service to limit a region in which the user needs to be located, so that the user who executes the service satisfies a regional need for the service.

It is worthwhile to note that the terminal should have a function of establishing short-range communication with the short-range communication device. For example, if the terminal does not support an NFC function, when the short-range communication device is an NFC chip, the terminal cannot establish a connection with the short-range communication device.

Step S102: Send a read request to the short-range communication device based on the short-range connection with the short-range communication device, to cause the short-range communication device to return verification information based on the short-range connection.

In one or more embodiments of this specification, after establishing the short-range connection with the short-range communication device, the terminal can send the read request to the short-range communication device (203) based on the short-range connection. The short-range communication device receives the read request, determines the verification information based on the read request, and returns the verification information to the terminal based on the short-range connection (204).

For example, the read request sent by the terminal can include an instruction for reading specific data stored in the short-range communication device. If the verification information is to be obtained, the terminal can set, in the read request, an instruction for obtaining the verification information. The short-range communication device receives the read request, and obtains, based on the instruction in the read request for obtaining the verification information, the verification information from data stored in the short-range communication device. The verification information can include a verification identifier of the short-range communication device, and the verification identifier represents uniqueness of the short-range communication device. The verification identifier can be set when the short-range communication device is produced, or can be generated based on a service need. This is not limited in this specification.

If the short-range communication device is an NFC card, because the NFC card has a unique identifier (UID) during production, the UID can be determined as a verification identifier. A virtual ID can also be generated based on a service need, and the virtual ID is determined as a verification identifier, and stored in the short-range communication device. Specifically, a region number is determined based on the regional need for the service, and the region number is a virtual ID, that is, the region number is a verification identifier.

After obtaining the verification information, the short-range communication device can return the verification information to the terminal through the short-range connection.

Step S104: Receive the verification information returned by the short-range communication device.

Step S106: Send an access request including the verification information to a service platform, to cause the service platform to return a service interface based on the verification information.

After receiving the verification information, the terminal can send the access request including the verification information to the service platform (205), to obtain the service interface. The service platform receives the access request sent by the terminal, and performs qualification verification on the user based on the verification information in the access request. When the verification succeeds, the service interface is obtained, and the service interface is returned to the terminal (206).

During qualification verification, the service platform needs to verify whether the verification information received by the terminal is forged information. The forged information can be sent by a forged short-range communication device, or can be directly forged.

For example, if the verification information is a verification identifier, the service platform can determine whether an identifier that matches the verification identifier exists in a pre-stored verification identifier set. If the identifier that matches the verification identifier exists, it indicates that the verification information is not forged information. Then, the service platform determines the service interface based on the verification identifier and a pre-stored correspondence between verification identifiers and service interfaces, and returns the service interface to the terminal. The terminal receives and displays the service interface returned by the service platform (207), so that the user can execute a service based on the service interface displayed by the terminal (208).

Generally, the short-range communication device is difficult to copy. Therefore, establishing a connection with the user by using the short-range communication device can ensure that the user who executes the service satisfies the regional need for the service. However, if another person forges the short-range communication device by using various technical means, the service platform can further perform qualification verification on the user by using the verification information to perform a check, so as to alleviate a case that a non-target user executes the service by forging the verification information, forging the short-range communication device, etc., and a subsequent execution effect of the service is affected.

For example, the service is a community facility experience survey, and target users are community residents. If non-target users fill in a questionnaire, because the non-community residents may not know and have not experienced the community facilities, collected information may be inaccurate, affecting a subsequent solution for improving the community facilities, and further affecting living experience of the community residents. Performing qualification verification by using the verification information can further alleviate a case that a non-target user executes the service and obtains benefits through service cheating. For example, in the above-mentioned lottery, if a user does not want to participate in the lottery on site but still wants to get a prize, the user may forge the verification information and/or forge the short-range communication device to obtain benefits.

It is worthwhile to note that, to improve security of obtaining the service interface by the terminal, and prevent others from stealing the service interface, the terminal and the service platform can exchange data through an encrypted channel, including the Hypertext Transfer Protocol Secure (HTTPS), etc.

Step S108: Receive and display the service interface returned by the service platform, for the user to execute a service based on the displayed service interface.

For example, if the service is a payment service, the service interface is a payment interface, and the user can tap a payment option on a payment page displayed by the terminal to perform payment.

In the above service execution method, the user establishes the short-range connection between the terminal and the short-range communication device, and the terminal sends the read request to the short-range communication device, to obtain the verification information and send the verification information to the service platform. The service platform returns the service interface to the terminal based on the verification information, and the user executes the service based on the service interface. In the method, the short-range connection is established between the terminal and the short-range communication device, thereby limiting a distance between the user and the short-range communication device. The short-range communication device can be placed at a specified location for an offline service, so that a user who executes the service needs to satisfy a regional need of the offline service. The service platform verifies the verification information, thereby ensuring authenticity of the short-range communication device, and alleviating service cheating performed by another person by using a forged short-range communication device.

For step S102, the short-range communication device can return an access address of the service platform to the terminal, to cause the terminal to send an access request for accessing the service interface to the service platform based on the access address.

The short-range communication device can further return, to the terminal, an application access address of an application (App) that establishes an association with the service platform. In this case, when step S106 is performed, the terminal can send the access request including the verification information to the application based on the application access address. The application receives the access request that is sent by the terminal and includes the verification information, and sends the verification information to the service platform, so that the service platform performs qualification verification on the user based on the verification information. After the verification succeeds, the service platform returns the service interface to the terminal through the application. It can also be understood that the application can serve as an intermediate party for the terminal to obtain the service interface, send the verification information to the service platform, receive the service interface, and then return the service interface to the terminal.

When interacting with the terminal, the short-range communication device can further return to-be-decoded service information to the terminal based on the short-range connection.

When step S106 is performed, the terminal receives the to-be-decoded service information returned by the short-range communication device based on the short-range connection. The to-be-decoded information can include the service interface, a service start moment, a service end moment, etc. In this case, the terminal can send an access request including the to-be-decoded service information and the verification information to the service platform. The service platform receives the access request, and performs qualification verification on the user based on the verification information. When the verification succeeds, the service platform does not need to perform verification identifier matching, but can obtain the service interface based on the to-be-decoded service information. Specifically, the to-be-decoded service information can be decoded to obtain the service interface, the service start moment, the service end moment, etc. Service validity verification is performed based on the service start moment and the service end moment. If the service is valid, the service interface is returned to the terminal.

It can be understood that, to enable the short-range communication device to store the to-be-decoded service information, the service platform can obtain the service information, including the service start moment, the service end moment, a service execution procedure, the service interface, etc., and then generate, based on the service information, a service code as the to-be-decoded service information. The to-be-decoded service information is written into the short-range communication device by using a write device. The service information is encoded to further ensure security of service execution. A specific encoding method is not limited in this specification. In addition, the to-be-decoded service information can be alternatively written into the short-range communication device by using another electronic device. A specific type of the device, such as an NFC card reader, is not limited in this specification.

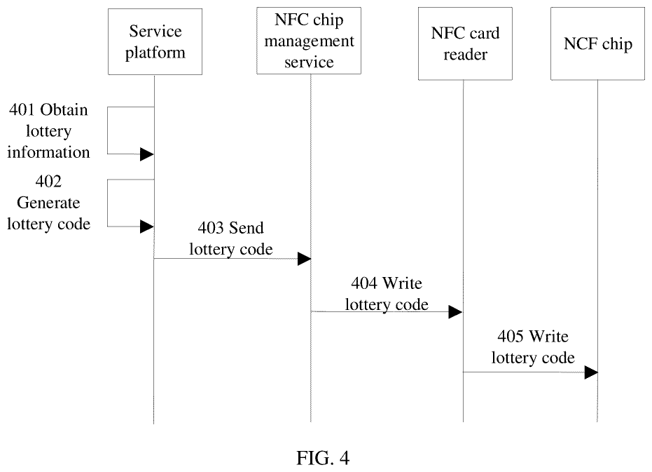

FIG. 4 is a flowchart illustrating determining to-be-decoded service information according to an example embodiment.

In this example embodiment, the service is a lottery, and the short-range communication device is an NFC chip, the service platform obtains lottery information (401), including a lottery quantity, a prize level, a prize type, a lottery page, etc. A lottery code is generated (402) based on the lottery information, and sent to an NFC chip management service that is invoked (403), so that the NFC chip management service writes the lottery code (404) into an NFC card reader, and the card reader writes the lottery code into the NFC chip (405).

For step S102, to improve security of service execution and prevent another person from forging the short-range communication device for cheating and affecting a service execution effect, the generated verification information can be further encrypted according to a predetermined encryption method. In this case, the short-range communication device stores encrypted verification information, and further returns the encrypted verification information to the terminal. A specific encryption method is not limited in this specification. The predetermined encryption method includes encryption using a hash function, etc.

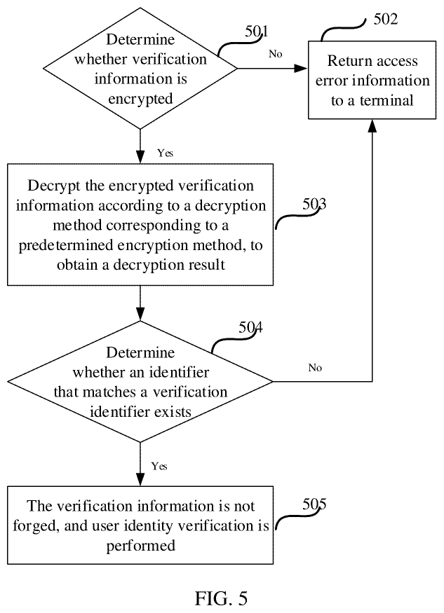

For step S106, FIG. 5 is a flowchart illustrating qualification verification according to an example embodiment.

In this example embodiment, the short-range communication device stores the encrypted verification information, and after receiving the access request, the service platform can first determine whether the verification information is encrypted (501). If no, it indicates that the verification information may be forged, and access error information is returned to the terminal (502). The terminal displays the access error information to the user, to prompt the user that the short-range communication device is faulty. If the verification information is encrypted information, the service platform can decrypt the encrypted verification information according to a decryption method corresponding to the predetermined encryption method, to obtain a decryption result (503). If the decryption result is a verification identifier, the service platform can determine whether an identifier that matches the verification identifier exists in a pre-stored verification identifier set (504). If the identifier that matches the verification identifier exists, the verification information is not forged, and user identity verification can be performed (505).

In addition, when interacting with the service platform, the terminal further sends identity information of the user to the service platform. Therefore, the service platform can further verify the identity information of the user corresponding to the terminal. The identity information can represent uniqueness of an identity of the user, and include an identity identifier, etc. This is not limited in this specification. After receiving the identity information, the service platform performs identity matching in a historical identity information set to determine whether the service interface has been sent to the terminal of the user. If yes, it indicates that the user does not execute the service for the first time, and whether to send the service interface to the terminal of the user is determined based on a predetermined quantity of times that the user can execute the service in the service need and a quantity of times that the service interface has been sent to the terminal of the user. If the user has executed the service the predetermined quantity of times, prompt information indicating that the user has executed the service is returned to the terminal of the user.

If the service interface has not been sent to the terminal of the user, it indicates that the user executes the service for the first time, identity information of the user is recorded, and the service interface is returned to the terminal of the user. In addition, if the quantity of times that the user executes the service is limited in the service need, a quantity of times that the service interface has been sent to the user is recorded. If there is no limitation, the quantity of sending times does not need to be recorded.

When the service platform obtains the service interface through verification identifier matching, the service platform can further determine, based on a timestamp of sending the access request by the terminal and the pre-stored service start moment and end moment, whether to return the service interface to the terminal. For example, assuming that the service start moment is 0 o'clock on Mar. 1, 2023, and the service end moment is 23 o'clock on Apr. 7, 2023, if the timestamp of sending the access request by the terminal falls within 0 o'clock on Mar. 1, 2023 to 23 o'clock on Apr. 7, 2023, the service interface is returned to the terminal; otherwise, prompt information indicating that the service has ended is returned to the terminal.

After step S108 is performed, the service platform can further interact with the terminal to store interaction data of the user in the service interface for subsequent service evaluation and user behavior analysis.

It is worthwhile to note that immutability of data such as the verification information and the service interface can be further enhanced with reference to a blockchain technology and a privacy technology, thereby improving service transparency and trustworthiness.

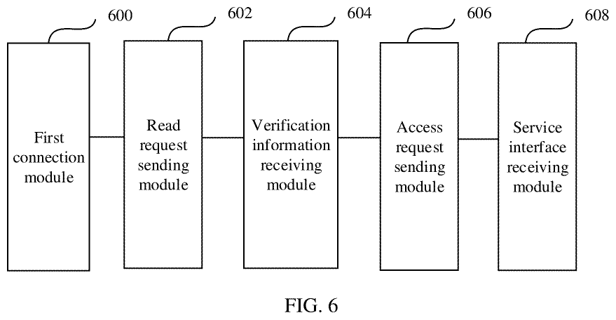

FIG. 6 is a schematic diagram illustrating a service execution apparatus according to an example embodiment. As shown in FIG. 6, the apparatus may be used in a terminal, and include: a first connection module 600, configured to establish a short-range connection with a short-range communication device in response to a short-range connection operation of a user; a read request sending module 602, configured to send a read request to the short-range communication device based on the short-range connection with the short-range communication device, so that the short-range communication device returns verification information based on the short-range connection; a verification information receiving module 604, configured to receive the verification information returned by the short-range communication device; an access request sending module 606, configured to send an access request including the verification information to a service platform, so that the service platform returns a service interface based on the verification information; and a service interface receiving module 608, configured to receive and display the service interface returned by the service platform, so that the user executes a service based on the displayed service interface.

In some embodiments, the short-range communication device includes at least one of a near field communication chip, a radio frequency identification chip, and a Bluetooth device.

In some embodiments, the apparatus further includes: a to-be-decoded service information receiving module, configured to receive to-be-decoded service information returned by the short-range communication device based on the short-range connection; the access request further includes the to-be-decoded service information; and the access request sending module is specifically configured to send the access request including the verification information to the service platform, so that the service platform performs qualification verification on the user based on the verification information, and obtains the service interface based on the to-be-decoded service information when the verification succeeds.

This specification also provides a service execution apparatus used in a service platform, and the apparatus includes: an access request receiving module, configured to receive an access request that is sent by a terminal and includes verification information, where the verification information is obtained by the terminal based on a short-range connection established with a short-range communication device; a qualification verification module, configured to perform qualification verification on a user based on the verification information; a service interface obtaining module, configured to obtain a service interface when the verification succeeds; and a service interface returning module, configured to return the service interface to the terminal, so that the user executes a service based on the service interface displayed by the terminal.

In some embodiments, the access request further includes to-be-decoded service information returned by the short-range communication device to the terminal based on the short-range connection; and the service interface obtaining module is specifically configured to decode the to-be-decoded service information to obtain the service interface.

In some embodiments, the service interface obtaining module is specifically configured to determine the service interface based on the verification information and a pre-stored correspondence.

In some embodiments, the apparatus further includes: a write module, configured to obtain service information; generate, based on the service information, a service code as to-be-decoded service information; and write the to-be-decoded service information into the short-range communication device by using a write device.

This specification also provides a service execution apparatus used in a short-range communication device, and the apparatus includes: a second connection module, configured to establish a short-range connection with a terminal of a user in response to a short-range connection operation of the user; a read request receiving module, configured to receive a read request sent by the terminal based on the short-range connection; a verification information determining module, configured to determine verification information based on the read request; and a verification information returning module, configured to return the verification information to the terminal based on the short-range connection, so that the terminal sends the verification information to a service platform, and obtains and displays a service interface returned by the service platform, and the user executes a service displayed in the service interface.

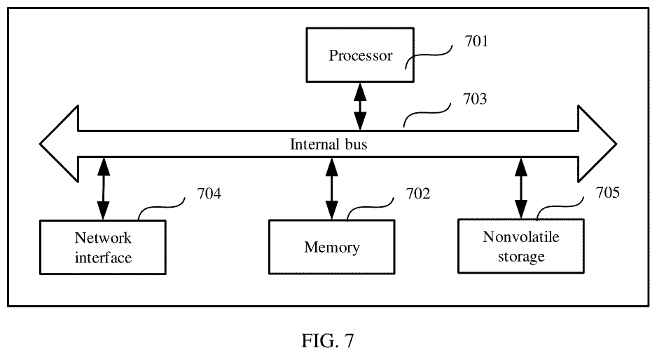

FIG. 7 is a schematic diagram of an electronic device according to an example embodiment. The electronic device may be any one of the terminal, the service platform, or the short-range communication device described above. As shown in FIG. 7, the electronic device includes a processor 701 and a memory 702, and may further include an internal bus 703, a network interface 704, and a nonvolatile storage 705, or other hardware needed. The processor 701 may execute instructions in the memory 702 to perform the above service execution method.

In some embodiments, a programmable logic device (PLD) (for example, a field programmable gate array (FPGA)) can be used to perform the above service execution method. The PLD is such an integrated circuit, and a logical function of the PLD is determined by a user through device programming. The designer performs programming to “integrate” a digital system into a PLD without requesting a chip manufacturer to design and produce an application-specific integrated circuit chip. In addition, at present, instead of manually manufacturing an integrated circuit chip, such programming is mostly implemented by using “logic compiler” software. The logic compiler software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

In some embodiments a controller can also be used to perform the above service execution method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or an embedded microprocessor. The memory controller can also be implemented as a part of control logic of a storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, an embedded microcontroller, etc. Therefore, the controller can be considered as a hardware component, and an apparatus that is configured to implement various functions and that is included in the controller can also be considered as a structure in the hardware component. Alternatively, the apparatus configured to implement various functions can even be considered as both a software module implementing a method and a structure in the hardware component.

Systems, apparatuses, modules, or units that are set forth in the previous implementations can be embodied by a computer chip or an entity or by a product with a specific function. A typical implementation device is a computer. For example, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the above apparatus is separately described by dividing the apparatus into various modules or units based on functions. Each of the modules or units can be implemented in hardware, software, or a combination of hardware and software.

This specification further provides a non-transitory computer-readable storage medium. The storage medium stores instructions such as a computer program, and when the computer program is executed by a processor of a device, the device is caused to perform the above service execution method.

Examples of the computer storage medium include but are not limited to a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage or another magnetic storage device, or any other non-transmission medium. The computer storage medium can be configured to store information accessible to a computing device. As described in this specification, the computer-readable medium does not include computer-readable transitory media such as a modulated data signal and a carrier.

In some embodiments, a program module can be used to perform the above service execution method. Typically, program modules include routines, programs, objects, components, data structures, etc. that perform specific tasks or implement specific abstract data types. The method described above can also be implemented in distributed computing environments. In the distributed computing environments, tasks are performed by remote processing devices connected through a communication network. In a distributed computing environment, the program module can be located in both local and remote computer storage media including storage devices.

In the service execution method provided in this specification, the terminal establishes the short-range connection with the short-range communication device based on the short-range connection operation of the user, and the terminal sends the read request to the short-range communication device based on the short-range connection with the short-range communication device, so that the short-range communication device returns the verification information based on the short-range connection. Then, the terminal receives the verification information returned by the short-range communication device, and further sends the access request including the verification information to the service platform, so that the service platform returns the service interface based on the verification information. Finally, the terminal receives and displays the service interface returned by the service platform, so that the user executes the service based on the displayed service interface.

In the method, the short-range connection is established between the terminal and the short-range communication device, thereby limiting a distance between the user and the short-range communication device. The short-range communication device can be placed at a specified location for an offline service, so that a user who executes the service needs to satisfy a regional need of the offline service. The service platform verifies the verification information, thereby ensuring authenticity of the short-range communication device, and alleviating service cheating performed by another person by using a forged short-range communication device.

The embodiments of this specification are described in a progressive manner. For same or similar parts in the embodiments, references can be made to each other. The device embodiments are basically similar to the method embodiments, and for related parts, reference can be made to descriptions in the method embodiments.

The above descriptions are merely example embodiments of this specification, and are not intended to limit this specification. A person skilled in the art can make various modifications and changes to this specification. Any modification, equivalent replacement, improvement, etc. made without departing from the spirit and principle of this specification shall fall within the scope of the appending claims.

1. A service execution method, applied to a terminal, and comprising:
establishing a short-range connection with a short-range communication device in response to a short-range connection operation of a user;
sending a read request to the short-range communication device based on the short-range connection with the short-range communication device, to cause the short-range communication device to return verification information based on the short-range connection;
receiving the verification information returned by the short-range communication device;
sending an access request comprising the verification information to a service platform, to cause the service platform to return a service interface based on the verification information; and
receiving and displaying the service interface returned by the service platform, for the user to execute a service based on the displayed service interface.

2. The method according to claim 1, wherein the short-range communication device comprises at least one of a near field communication chip, a radio frequency identification chip, or a Bluetooth device.

3. The method according to claim 1, further comprising:
receiving to-be-decoded service information returned by the short-range communication device based on the short-range connection;
wherein the access request further comprises the to-be-decoded service information; and
the sending the access request comprising the verification information to the service platform, comprises:
sending the access request comprising the verification information to the service platform, to cause the service platform performs qualification verification on the user based on the verification information, and to obtain the service interface based on the to-be-decoded service information when the verification succeeds.

4. A service execution method, applied to a service platform, and comprising:
receiving an access request that is sent by a terminal and comprises verification information, wherein the verification information is obtained by the terminal based on a short-range connection established with a short-range communication device;
performing qualification verification on a user based on the verification information;
obtaining a service interface when the verification succeeds; and
returning the service interface to the terminal, to cause the user to execute a service based on the service interface displayed by the terminal.

5. The method according to claim 4, wherein the access request further comprises to-be-decoded service information returned by the short-range communication device to the terminal based on the short-range connection; and
the obtaining the service interface comprises:
decoding the to-be-decoded service information to obtain the service interface.

6. The method according to claim 4, wherein the obtaining the service interface comprises:
determining the service interface based on the verification information and a pre-stored correspondence.

7. The method according to claim 4, further comprising:
obtaining service information;
generating, based on the service information, a service code as to-be-decoded service information; and
writing the to-be-decoded service information into the short-range communication device by using a write device.

8. A service execution method, applied to a short-range communication device, and comprising:
establishing a short-range connection with a terminal of a user in response to a short-range connection operation of the user;
receiving a read request sent by the terminal based on the short-range connection;
determining verification information based on the read request; and
returning the verification information to the terminal based on the short-range connection, to cause the terminal to send the verification information to a service platform, and to obtain and display a service interface returned by the service platform, for the user to execute a service displayed in the service interface.

9. A terminal, comprising:
a processor; and
a memory storing instructions executable by the processor,
wherein the processor is configured to perform the service execution method according to claim 1.

10. A service platform, comprising:
a processor; and
a memory storing instructions executable by the processor,
wherein the processor is configured to perform the service execution method according to claim 4.

11. A short-range communication device, comprising:
a processor; and
a memory storing instructions executable by the processor,
wherein the processor is configured to perform the service execution method according to claim 8.

12. A non-transitory computer-readable storage medium having stored therein instructions that, when executed by a processor of a terminal, cause the terminal to perform the service execution method according to claim 1.

13. A non-transitory computer-readable storage medium having stored therein instructions that, when executed by a processor of a service platform, cause the service platform to perform the service execution method according to claim 4.

14. A non-transitory computer-readable storage medium having stored therein instructions that, when executed by a processor of a short-range communication device, cause the short-range communication device to perform the service execution method according to claim 8.
